(19) United States
(12) Patent Application Publication
(10) Pub. No.: US 2011/0038259 A1
(43) Pub. Date: Feb. 17, 2011

(54) Priority Policing of Requests with Deferred Determination of Priority Level

(75) Inventors: Shaun Jaikarran Bharrat, Manalapan, NJ (US); Kevin John Pilotte, Chester, NH (US); Tolga Asveren, Bordentown, NJ (US); Vijay Subramanian, Chelmsford, MA (US); Vince Hung-Kwan Choy, Hazlet, NJ (US)

Correspondence Address: PROSKAUER ROSE LLP, ONE INTERNATIONAL PLACE, BOSTON, MA, 02110, US

(73) Assignee: Sonus Networks, Inc., Westford, MA (US)

(21) Appl. No.: 12/702,993

(22) Filed: Feb. 9, 2010

Related U.S. Application Data
(60) Provisional application No. 61/230,172, filed on Jul. 31, 2009.

(51) Int. Cl. H04L 12/56

(52) U.S. Cl. 370/230

(57) ABSTRACT

Methods and apparatuses, including computer program products, are described for priority policing of requests with deferred determination of priority level. The method includes directing each packet in a data stream to a policer. The method also includes determining whether to allow, reject, or conditionally pass each packet through the policer based on parameters associated with the policer. The method also includes directing each packet conditionally passed by the policer to a classifier associated with the policer. The method also includes determining, by the classifier, a priority value of each packet received from the policer. The method also includes directing, by the classifier, each prioritized packet to the policer. The method also includes determining whether to allow or reject each prioritized packet through the policer based on the priority value.

### RELATED APPLICATIONS

This application claims benefit of U.S. Provisional Application No. 61/230,172, filed Jul. 31, 2009, the entire specification of which is incorporated by reference herein.

### FIELD OF THE INVENTION

The subject matter of this application relates generally to methods and apparatuses, including computer program products, for priority policing of requests with deferred determination of priority level.

### BACKGROUND OF THE INVENTION

The fixed and limited resources associated with communications networks generally require a strategy for apportioning these resources among the many subscribers of the network. An additional consideration to ensure that hyperactivity on the part of one or some subscribers does not affect the usability of the network for other subscribers is enforcement of the apportionment strategy. Typically, each subscriber (e.g., a particular entity utilizing the network) is ascribed both an absolute limit on the number of resources allowed (e.g., number of calls and number of IM sessions) and also a limit on the rate of requests. The restrictions on absolute resource limits are usually implemented by some counting scheme, and the rate limits are enforced through some form of policing. Policing of network traffic commonly entails restricting the request rate from a particular entity to specified and desired parameters These parameters typically include both average request rates and burst sizes. The basic policing schemes all work well when all the requests from a subscriber are of the same class and characteristics.

However, many protocols allow for the establishment of very disparate services on the same infrastructure. The SIP protocol is particularly flexible and allows for the establishment of, for example, telephony calls, instant messaging, presence watching, and conferencing. Often, the sessions are not considered equivalent in importance, cost, or based on a variety of other metrics. Hence, some session types require priority over other session types from that same customer.

A basic building block for implementing traffic policing involves use of a policer. A policer receives network traffic (e.g., in packet form) and determines whether to allow the traffic to progress further in the network. Typically, the policer makes this determination based on attributes of the traffic, as well as a cost associated with a level of work the policer must do to allow the traffic to progress further. As a result, the policer locally maintains a credit amount against which the cost of allowing a unit of data to progress is charged. The policer replenishes its credit amount in a defined unit of time interval to ensure that sufficient credit is available for subsequent units of data to be allowed. For example, if ten credits out of 100 are used within one second, then the policer will replenish ten credits in the next second to bring its total credit amount back to 100.

A common type of policer is a multi-threshold token bucket policer. The token bucket policer includes a bucket where the size of the bucket is the desired burst size (B_{c}). The bucket is filled with tokens at the desired policing rate (R_{c}). After a certain time interval (Tᵢ), therefore, the bucket will have Tᵢ×R_{c} tokens. The number of tokens can never exceed B_{c} because once the token count reaches the bucket size, the excess tokens spill out and are lost. The bucket has a separate threshold, or floor Fₚ, for each priority level within the overall traffic stream, with the relative level of each floor determining the degree of preference of one priority over another. If requests of priority A are of higher priority than requests of priority B, then Fₐ>F_{b}.

Using a multi-threshold token bucket policer, policing of a traffic stream works as follows: when a packet of priority p is presented to the policer, the bucket is checked for tokens above Fₚ. If a token above Fₚ is present, then it is removed from the bucket and the packet is passed. If there are no tokens above Fₚ, then the packet is disallowed. Note that if the aggregate packet arrival rate Rₐ is exactly the policing rate R_{c}, then on average all packets will be allowed and the token level in the bucket will remain unchanged. If the packet arrival rate Rₐ is less than the policing rate Rₑ, then the bucket will fill up to a maximum of Bₑ and a burst of packets beyond the policing rate Rₑ will be allowed. Finally, if the packet arrival rate Rₐ is greater than the policing rate, preference is given to the higher priority traffic and the token level in the bucket decreases; as the token level drops below each priority floor, traffic of the lowest priorities are dropped first. On average, only R_{c} of the packet arrival rate will be allowed through, with the priority mix depending on the relative priority floor levels and priority mix of Rₐ.

### SUMMARY

In general overview, the techniques described herein are related to policing and prioritizing data traffic transmitted through a communications network, where the traffic can be related to a number of disparate services. The techniques provide a multi-stage policing approach, allowing for policing the data traffic in the context of a priority value assigned to specific segments of the traffic. The techniques also minimize the amount of effort expended by the policing system by policing the traffic close to the ingress point, while only prioritizing that portion of the traffic in the same policing stage where prioritization is required to determine whether to allow or reject the traffic (e.g., a normal telephone call versus an emergency telephone call). The techniques advantageously police received packets before parsing or decoding the packets, thereby avoiding the expensive operation of decoding each packet and preventing destabilization of the system when presented with high load or an attack scenario. In addition, if traffic is not allowed through the subsequent policing stages due to rate or burst violations, the techniques advantageously can undo a previously-incurred charge associated with allowing the traffic in a previous policing stage. As a result, the techniques can ensure that subsequent data traffic is not affected by a decision to allow or deny the traffic through one or more of the policing stages.

The invention, in one aspect, features a method for priority-aware policing of data services. The method includes directing each packet in a data stream to a policer. The method also includes determining whether to allow, reject, or conditionally pass each packet through the policer based on parameters associated with the policer. The method also includes directing each packet conditionally passed by the policer to a classifier associated with the policer. The method also includes determining, by the classifier, a priority value of each packet received from the policer. The method also includes directing, by the classifier, each prioritized packet to the policer. The method also includes determining whether to allow or reject each prioritized packet through the policer based on the priority value.

The invention, in another aspect, features a method for priority-aware policing of data services. The method includes directing each packet in a data stream to a priority policer. The method also includes determining whether to allow, reject, or conditionally pass each packet through the priority policer based on parameters associated with the priority policer. The method also includes determining a minimum priority value for each packet conditionally passed by the priority policer. The method also includes directing each packet conditionally passed by the priority policer and the minimum priority value associated with each packet to a classifier associated with the priority policer. The method also includes determining, by the classifier, a priority value for each packet received from the priority policer. The method also includes rejecting, by the classifier, each packet if the determined priority value for each packet is less than the minimum priority value associated with each packet. The method also includes directing, by the classifier, each packet to the priority policer if the priority value for each packet is greater than or equal to the minimum priority value associated with each packet. The method also includes determining whether to allow or reject each packet through the priority policer based on the determined priority value.

The invention, in another aspect, features a method for priority-aware policing of data services with N policing stages, wherein N is greater than 2, and a classifier. The method includes directing each packet in a data stream to a policer in a policing stage K. The method also includes determining whether to allow, reject, or conditionally pass each packet through the policer in the policing stage K based on parameters associated with the policer in the policing stage K. The method also includes directing each packet conditionally passed by the policer in the policing stage K to the classifier. The method also includes determining, by the classifier, a priority value of the packet received from the policer in the policing stage K. The method also includes directing, by the classifier, the packet and the priority value of the packet to the policer in the policing stage K. The method also includes determining whether to allow or reject the packet through the policer in the policing stage K based on the priority value received from the classifier. The method also includes directing each packet allowed by the policer in the policing stage K and the priority value of the packet to a policer in a subsequent policing stage K+1. The method also includes repeating steps b-g for each of the N policing stages.

The invention, in another aspect, features a method for priority-aware policing of data services with N policing stages, wherein N is greater than 2. The method includes directing each packet in a data stream to a policer in a policing stage K. The method also includes determining whether to allow, reject, or conditionally pass each packet through the policer in the policing stage K based on parameters associated with the policer in the policing stage K. The method also includes directing each packet conditionally passed by the policer in the policing stage K to a classifier in the policing stage K. The method also includes determining, by the classifier in the policing stage K, a priority value of the packet received from the policer in the policing stage K. The method also includes directing, by the classifier in the policing stage K, the packet and the priority value of the packet to the policer in the policing stage K. The method also includes determining whether to allow or reject the packet based on the priority value of the packet received from the classifier in the policing stage K. The method also includes directing each packet allowed by the policer in the policing stage K and the priority value of the allowed packet to a policer in a subsequent policing stage K+1. The method also includes repeating steps b-g for each of the N policing stages.

The invention, in another aspect, features a computer program product, tangibly embodied in a computer-readable storage medium, for priority-aware policing of data services. The computer program product includes instructions operable to cause a data processing apparatus to direct each packet in a data stream to a policer. The computer program product also includes instructions operable to cause a data processing apparatus to determine whether to allow, reject, or conditionally pass each packet through the policer based on parameters associated with the policer. The computer program product also includes instructions operable to cause a data processing apparatus to direct each packet conditionally passed by the policer to a classifier associated with the policer. The computer program product also includes instructions operable to cause a data processing apparatus to determine, by the classifier, a priority value of each packet received from the policer. The computer program product also includes instructions operable to cause a data processing apparatus to direct, by the classifier, each prioritized packet to the policer. The computer program product also includes instructions operable to cause a data processing apparatus to determine whether to allow or reject each prioritized packet through the policer based on the priority value.

The invention, in another aspect, features a system for priority-aware policing of data services. The system includes a policer configured to determine whether to allow, reject, or conditionally pass each packet in a data stream through the policer based on parameters associated with the policer. The policer is also configured to direct each packet conditionally passed by the policer to a classifier associated with the policer. The classifier is configured to determine a priority value of each packet received from the policer. The classifier is also configured to direct each prioritized packet to the policer. The policer is also configured to determine whether to allow or reject each prioritized packet through the policer based on the priority value.

The invention, in another aspect, features a system for priority-aware policing of data services. The system includes means for directing each packet in a data stream to a policer. The system also includes means for determining whether to allow, reject, or conditionally pass each packet through the policer based on parameters associated with the policer. The system also includes means for directing each packet conditionally passed by the policer to a classifier associated with the policer. The system also includes means for determining, by the classifier, a priority value of each packet received from the policer. The system also includes means for directing, by the classifier, each prioritized packet to the policer. The system also includes means for determining whether to allow or reject each prioritized packet through the policer based on the priority value.

In some embodiments, any of the above aspects can include one or more of the following features. In some embodiments, determining whether to allow, reject, or conditionally pass each packet through the policer includes conditionally passing each packet through the policer and directing the conditionally passed packets to the classifier. In some embodiments, determining whether to allow, reject, or conditionally pass each packet through the policer comprises rejecting or conditionally passing each packet through the policer and directing the conditionally passed packets to the classifier. In some embodiments, determining a priority value for each packet received from the policer is based on one or more attributes of the packet. The one or more attributes of the packet can include at least one of content data associated with the packet or metadata associated with the packet. The content data associated with the packet can include at least one of data associated with one or more network protocol headers of the packet, data associated with one or more application headers of the packet or data associated with the packet payload. The metadata associated with the packet can include at least one of a packet arrival interface, upstream router identification, VLAN identification or access medium identification.

In some embodiments, the method includes charging the policer for each packet allowed by the policer, and not charging the policer for each packet conditionally passed through the policer to the classifier. In some embodiments, the method includes charging the policer for each packet allowed by the policer, charging the policer for each packet conditionally passed through the policer to the classifier, and undoing the charge for each packet conditionally passed through the policer to the classifier if the packet is dropped by the classifier. In some embodiments, the classifier directs each prioritized packet to the policer if the priority value of the prioritized packet is higher than a minimum priority value.

In some embodiments, the step of determining whether to allow, reject, or conditionally pass each packet through the policer occurs independently of any priority value associated with each packet. In some embodiments, the step of determining whether to allow, reject, or conditionally pass each packet through the policer is based on a minimum priority value. The minimum priority value can be the lowest priority value at which the policer would unconditionally allow a packet.

Any of the embodiments described herein can contain one or more of the following advantages. In some embodiments, packets in the data stream are policed initially without regard to priority so as to avoid incurring substantial processing costs associated with prioritizing the packets. In some embodiments, packets rejected by the classifier or by subsequent policing stages do not affect the processing of later-arriving packets because charges attributed to the policing stages which allowed the packet are undone.

### DESCRIPTION OF FIGURES

FIG. 1 is a block diagram of an exemplary system for priority policing of requests with deferred determination of priority level, according to an illustrative embodiment of the invention.

FIG. 2 is a flow diagram of an exemplary method for priority policing of requests with deferred determination of priority level, according to an illustrative embodiment of the invention.

FIG. 3 is a block diagram of an exemplary multi-stage system with a single classifier for priority policing of requests with deferred determination of priority level, according to an illustrative embodiment of the invention.

FIG. 4 is a block diagram of an exemplary multi-stage system with a separate classifier per stage for priority policing of requests with deferred determination of priority level, according to an illustrative embodiment of the invention.

### DETAILED DESCRIPTION

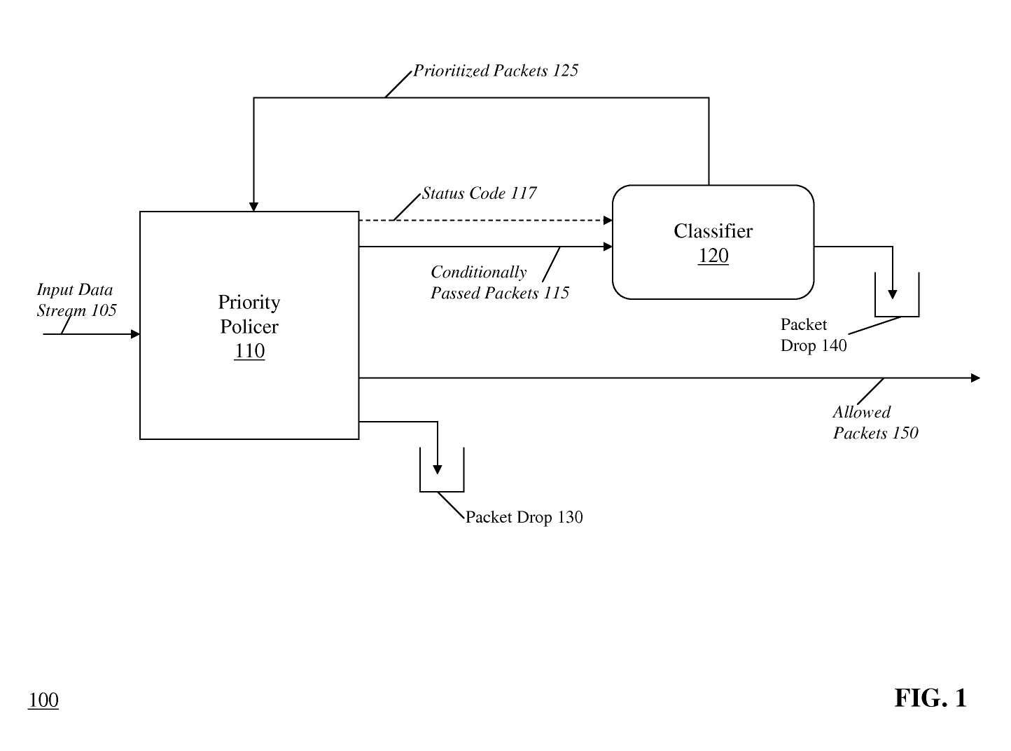

FIG. 1 is a block diagram of an exemplary system 100 for priority policing of requests with deferred determination of priority level, according to an illustrative embodiment of the invention. The system 100 includes an input data stream 105, a priority policer 110, a classifier 120, a policer packet drop 130, and a classifier packet drop 140.

In some embodiments, the classifier 120 is a hardware or software module (e.g., implemented on a processor or other computing device) which determines a priority value to assign to the packets received from the priority policer 110. The classifier 120 determines the priority value based on one or more of: the contents of a network protocol header associated with the packet, application data associated with the packet, and metadata (e.g., an input interface, a VLAN identification) associated with the packet. For example, the classifier 120 can determine a priority value based on a source IP address of the packet, a destination IP address of the packet, a source transport port of the packet, a destination transport port of the packet, a protocol type of the packet, a SIP message type of the packet, or a SIP callid (e.g., an identifier that refers to the call session) associated with the packet.

In some embodiments, the policer packet drop 130 is a data link between the priority policer 110 and a device outside the system 100 over which the dropped packet is transmitted. In other embodiments, the policer packet drop 130 is a physical memory location where dropped packets are stored for later processing. In still other embodiments, the policer packet drop 130 is a device or module that destroys the dropped packets.

In some embodiments, the classifier packet drop 140 is a data link between the classifier 120 and a device outside the system 100 over which the dropped packet is transmitted. In other embodiments, the classifier packet drop 140 is a physical memory location where dropped packets are stored for later processing. In still other embodiments, the classifier packet drop 140 is a device or module that destroys the dropped packets.

The system 100 receives an input data stream 105. For example, the input data stream 105 can be received from a device associated with a communications carrier or service provider. The input data stream 105 generally consists of a series of packets, which are units of data formatted for transmission over a communications network. A packet generally contains metadata and a payload. The packet metadata includes attributes related to the packet (e.g., arrival information, destination information, origin information, encoding protocols, or structure of information in the packet). The payload contains the user data to be transmitted.

While each of the components 110, 120, 130, and 140 are represented in FIG. 1 as being contained within a single physical device, the components can alternatively reside in two or more different physical devices. The components and/or devices can communicate via a communications network (not shown), such as, for example, a local network (e.g., LAN) or a wide area network (e.g., Internet).

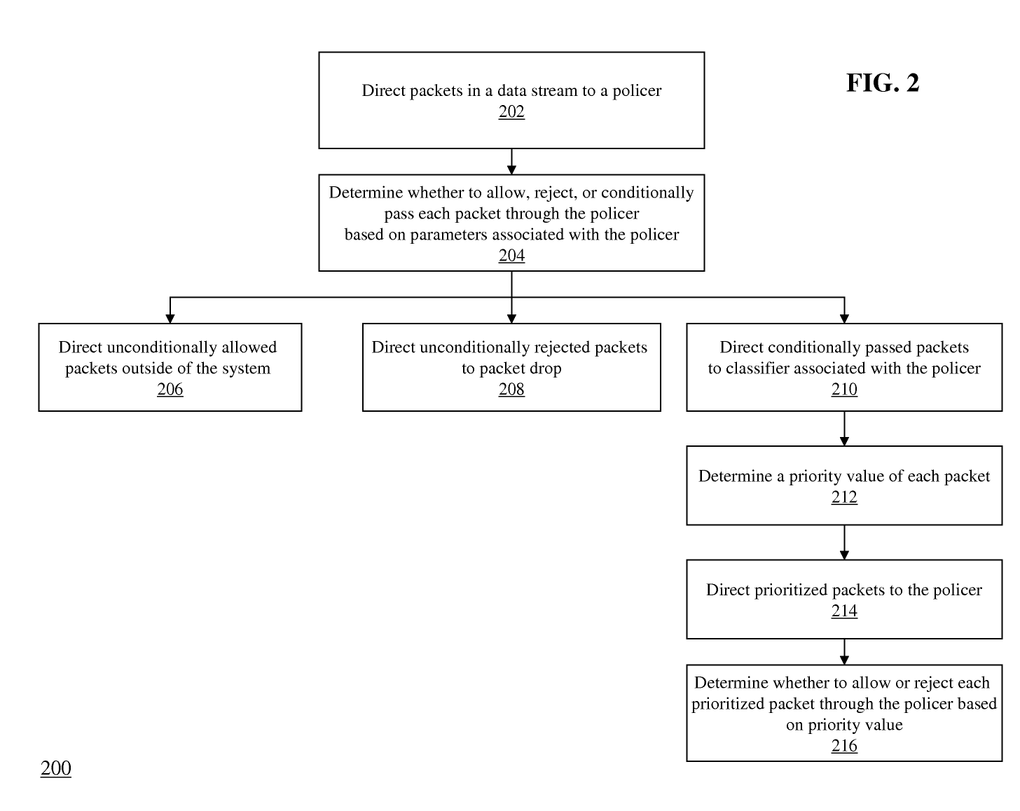

FIG. 2 is a flow diagram 200 of an exemplary method for priority policing of requests with deferred determination of priority level using, for example, the system 100 of FIG. 1, according to an illustrative embodiment of the invention. Packets in the input data stream 105 are directed (202) to the priority policer 110. The packets in the input data stream 105 are not classified (e.g., assigned a priority value) when received by the priority policer 110. For example, assigning a priority value to the packets in the input data stream 105 may require additional processing (e.g., parsing) of the packets which occurs in a later step of processing by the system 100. In another example, the cost (e.g., the amount of work required by the system 100) to assign a priority value to the packets in the input data stream 105 may be high enough that the system 100 only assigns the priority value to certain packets and not for every packet in the input data stream 105.

The priority policer 110 determines (204) whether to allow, reject, or conditionally pass each packet through the priority policer 110 based on parameters associated with the priority policer 110. Upon receiving an unclassified packet from the input data stream 105, the priority policer 110 determines if the packet can be unconditionally allowed. For example, if the priority policer 110 is a multi-threshold token bucket policer, the priority policer 110 unconditionally allows a packet if at least one token is available above the threshold associated with the lowest priority value (e.g., the highest threshold in the token bucket policer). In this example, the packet is not assigned a priority value because the priority policer 110 allows the packet through the policer 110 without regard to any priority value. The priority policer 110 directs (206) unconditionally allowed packets (e.g., allowed packets 150) outside of the system 100 (e.g., for further processing by other modules of the system 100, for transmission to other devices or systems). Also, in this example, the priority policer 110 is charged (e.g., a token is removed) upon unconditionally allowing a packet.

If the packet is not unconditionally allowed, the priority policer 110 determines whether to reject or conditionally pass the packet through the priority policer 110. For example, if the priority policer 110 is a multi-threshold token bucket policer, the priority policer 110 rejects the packet if there are no tokens above the threshold associated with the highest priority value (e.g., the lowest threshold in the token bucket policer). In this example, the packet is not assigned a priority value because the priority policer 110 rejects the packet without regard to any priority value. The priority policer 110 directs (208) rejected packets to the packet drop 130 associated with the priority policer 110. Also, in this example, the priority policer 110 is not charged (e.g., a token is not removed) upon rejecting a packet.

If the priority policer 110 does not unconditionally allow or reject the packet, the priority policer 110 determines that the packet is conditionally passed through the priority policer 110. For example, if the priority policer 110 is a multi-threshold token bucket policer, the priority policer 110 determines the lowest priority value P(k) (e.g., the highest threshold in the token bucket policer) for which the policer 110 has an available token. The priority policer 110 returns a status code (e.g., status code 117) indicating that the packet should be rejected if the priority value associated with the packet is eventually determined to be less than P(k).

In some embodiments, the priority policer 110 does not unconditionally allow or reject packets received from the input data stream 105. Instead, the priority policer 110 conditionally passes each packet (e.g., conditionally passed packets 115) received from the input data stream 105 to the classifier 120. The classifier 120 determines the priority value of the packets and directs the prioritized packets (e.g., prioritized packets 125) to the priority policer 110. The priority policer 110 then determines whether to allow or reject the prioritized packets 125 based on the priority value.

In some embodiments, the priority policer 110 does not unconditionally allow packets received from the input data stream 105. Instead, the priority policer 110 determines whether to reject packets received from the input data stream 105 (as illustrated above), or conditionally pass packets received from the input data stream 105 (as illustrated below).

The priority policer 110 directs (210) conditionally passed packets 115 to the classifier 120 associated with the priority policer 110. The priority policer 110 also directs the status code 117 indicating the lowest priority value P(k) to the classifier 120. In some embodiments, the priority policer 110 is not charged (e.g., a token is not removed) upon conditionally passing a packet since the system 100 has not yet fully processed the packet to determine whether the packet is allowed (e.g., allowed packets 150) through the system 100 or rejected. Charging (e.g., removing a token) for conditionally passed packets would cause the priority policer 110 to become unsynchronized with the number of packets actually allowed through the system 100, resulting in an overall policing rate that is below the expected rate.

The classifier 120 determines (212) a priority value of each packet received from the priority policer 110. In some embodiments, the classifier 120 determines the priority value based on one or more of: the contents of a network protocol header associated with the packet, application data associated with the packet, or metadata associated with the packet.

The classifier 120 compares the determined priority value of the packet with the status code 117 indicating the lowest priority value received from the priority policer 110 to determine whether to reject the packet or direct the packet back to the priority policer 110 with the determined priority value. For example, if the classifier 120 determines that the priority value of the packet is P(m), and P(m) is less than P(k), the classifier 120 directs the packet to the packet drop 140 associated with the classifier 120 because the priority value of the packet falls below the lowest priority value at which the priority policer 110 would allow a packet. In another example, if the classifier 120 determines that the priority value of the packet is P(s), and P(s) is greater than or equal to P(k), the classifier 120 directs (214) the packet to the priority policer 110 because the priority value of the packet meets or exceeds the lowest priority value at which the priority policer 110 would allow a packet. In this example, the classifier 120 directs (214) the determined priority value (e.g., P(s)) to the priority policer 110 along with the prioritized packet 125.

Upon receiving the prioritized packet 125 from the classifier 120, the priority policer 110 determines (216) whether to allow or reject the prioritized packet 125 through the priority policer 110 based on the priority value associated with the prioritized packet 125. For example, if the priority policer 110 is a multi-threshold token bucket policer, the priority policer 110 compares the priority value associated with the prioritized packet with the priority value (e.g., the threshold in the token bucket policer) at which at least one token is available. If at least one token is available above the desired threshold, the priority policer 110 allows the packet (e.g., allowed packets 150) and the priority policer 110 is charged (e.g., a token is removed). If at least one token is not available above the desired threshold, the priority policer 110 rejects the packet by directing the packet to the packet drop 130 and the priority policer 110 is not charged (e.g., a token is not removed).

In some embodiments, if the priority policer 110 is a multi-threshold token bucket policer, the number of tokens available in the priority policer 110 decreases between the time that a packet is conditionally passed by the priority policer 110 and the time that the packet is directed back to the priority policer 110 after the classifier 120 determines a priority value for the packet. For example, the classifier 120 determines a priority value (e.g., P(m)) of the packet that meets or exceeds the status code indicating the lowest priority value (e.g., P(k)) as received from the priority policer 110 when the packet is conditionally passed to the classifier 120. As a result, the classifier 120 directs the packet back to the priority policer 110 with the priority value P(m). In the interim, the priority policer 110 may have unconditionally allowed packets (e.g., allowed packets 150) to cause the number of available tokens to fall below the threshold associated previously determined lowest priority value P(k) and below the threshold associated with the determined priority value P(m). When the priority policer 110 receives the prioritized packet (e.g., prioritized packets 125) and the determined priority value P(m), the priority policer 110 compares the determined priority value with the lowest priority value at which a token is available (e.g., now P(g), which is less than P(k) and P(m)). The priority policer 110 determines that P(g) is a lower priority value than P(m) and that no tokens are available at the threshold associated with priority value P(m). The priority policer 110 rejects the packet even though the classifier 120 had previously allowed the packet.

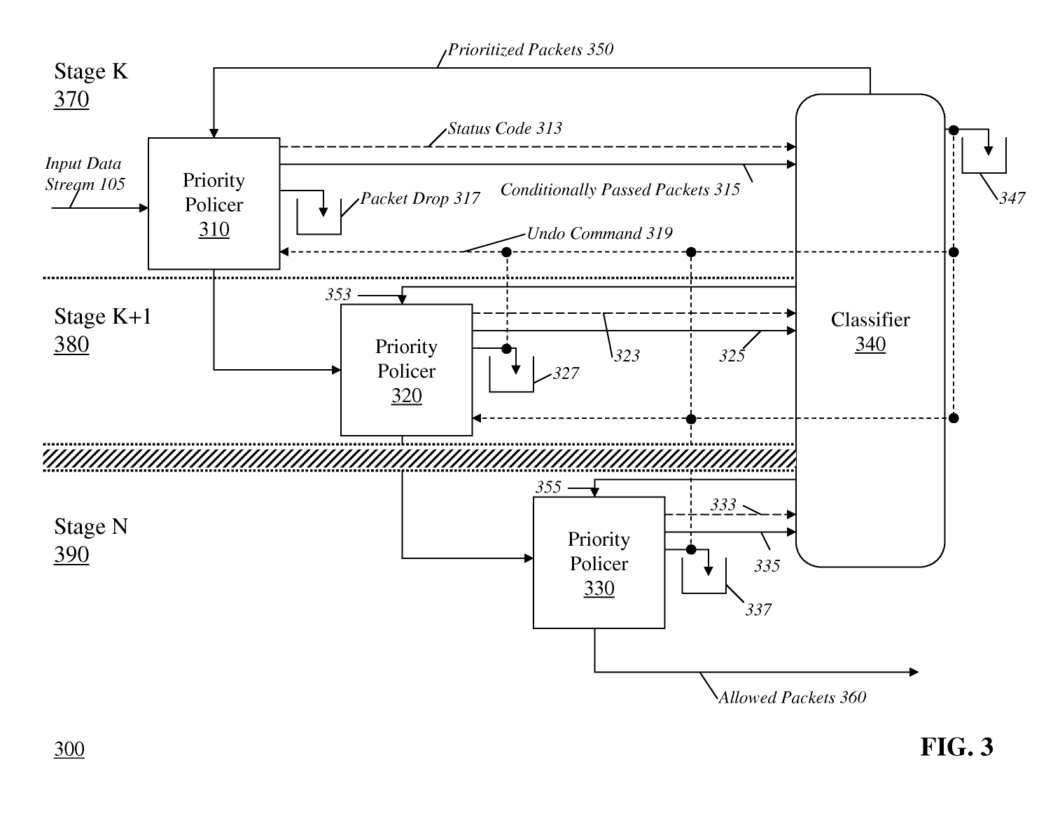

The above techniques and embodiments are described using a single stage policing structure (e.g., a priority policer (e.g., priority policer 110) and a classifier (e.g., classifier 120)). In some embodiments, however, the invention is implemented using any number of policing stages. FIG. 3 is a block diagram of an exemplary multi-stage system 300 with a single classifier 340 for priority policing of requests with deferred determination of priority level, according to an illustrative embodiment of the invention. The system 300 includes an input data stream 105, a plurality of policing stages (e.g., stage K 370, stage K+1 380, and stage N 390), and a single classifier 340. Each policing stage 370, 380, and 390 includes a priority policer (e.g., priority policer 310, 320, and 330 respectively). Each packet drop 317, 327, and 337 is associated with a priority policer (e.g., priority policer 310, 320, and 330, respectively). The packet drop 347 is associated with the classifier 340.

In some embodiments, a packet from the input data stream 105 proceeds to each policing stage 370, 380, and 390 before the system 300 determines the classification of the packet. In some embodiments, the policing stages 370, 380, and 390 are each associated with a different subset of packets that are policed in that stage. For example, a first policing stage (e.g., stage K 370) can police aggregate packets, a subsequent policing stage (e.g., stage K+1 380) can police SIP packets (e.g., a subset of the aggregate packets), and a further subsequent policing stage (e.g., stage N 390) can police SIP INVITE packets (e.g., a subset of the SIP packets).

In one embodiment, the priority policer 310 in the policing stage K 370 receives an input data stream 105. The input data stream 105 includes unclassified packets. The priority policer 310 determines whether to allow, reject, or conditionally pass each packet through the priority policer 319 in the policing stage K 370 based on parameters associated with the priority policer 310. Upon receiving an unclassified packet from the input data stream 105, the priority policer 310 determines if the packet can be unconditionally allowed. For example, if the priority policer 310 is a multi-threshold token bucket policer, the priority policer 310 unconditionally allows a packet if at least one token is available above the threshold associated with the lowest priority value (e.g., the highest threshold in the token bucket policer). In this example, the packet is not assigned a priority value because the priority policer 310 allows the packet through the policer 310 without regard to any priority value. The priority policer 310 directs unconditionally allowed packets to the priority policer 320 in the policing stage K+1 380. Also, in this example, the priority policer 310 is charged (e.g., a token is removed) upon unconditionally allowing a packet.

If the packet is not unconditionally allowed, the priority policer 310 determines whether to reject or conditionally pass the packet through the priority policer 310. For example, if the priority policer 310 is a multi-threshold token bucket policer, the priority policer 310 rejects the packet if there are no tokens above the threshold associated with the highest priority value (e.g., the lowest threshold in the token bucket policer). In this example, the packet is not assigned a priority value because the priority policer 310 rejects the packet without regard to any priority value. The priority policer 310 directs rejected packets to the packet drop 317 associated with the priority policer 310. Also, in this example, the priority policer 310 is not charged (e.g., a token is not removed) upon rejecting a packet.

If the priority policer 310 does not unconditionally allow or reject the packet, the priority policer 310 determines that the packet is conditionally passed through the priority policer 310. For example, if the priority policer 310 is a multi-threshold token bucket policer, the priority policer 310 determines the lowest priority value P(k) (e.g., the highest threshold in the token bucket policer) for which the policer 310 has an available token. The priority policer 310 returns a status code 313 indicating that the packet should be rejected if the priority value associated with the packet is eventually determined to be less than P(k).

The priority policer 310 directs conditionally passed packets 315 to the classifier 340. The priority policer 310 also directs the status code 313 indicating the lowest priority value P(k) to the classifier 340. The classifier 340 determines a priority value of each packet received from the priority policer 310 in the policing stage K 370. In some embodiments, the classifier 340 determines the priority value based on one or more of: the contents of a network protocol header associated with the packet, application data associated with the packet, or metadata associated with the packet.

The classifier 340 compares the determined priority value of the packet with the status code 313 indicating the lowest priority value received from the priority policer 310 to determine whether to reject the packet or direct the packet back to the priority policer 310 with the determined priority value. For example, if the classifier 340 determines that the priority value of the packet is P(m), and P(m) is less than P(k), the classifier 340 directs the packet to the packet drop 347 associated with the classifier 340 because the priority value of the packet falls below the lowest priority value at which the priority policer 310 would allow a packet.

In another example, if the classifier 340 determines that the priority value of the packet is P(s), and P(s) is greater than or equal to P(k), the classifier 340 directs the packet to the priority policer 310 because the priority value of the packet meets or exceeds the lowest priority value at which the priority policer 310 would allow a packet. In this example, the classifier 340 directs the determined priority value (e.g., P(s)) to the priority policer 310 along with the prioritized packet.

Upon receiving the prioritized packet (e.g., prioritized packets 350) from the classifier 340, the priority policer 310 determines whether to allow or reject the prioritized packet 350 through the priority policer 310 based on the priority value associated with the prioritized packet 350. For example, if the priority policer 310 is a multi-threshold token bucket policer, the priority policer 310 compares the priority value associated with the prioritized packet 350 with the priority value (e.g., the threshold in the token bucket policer) at which at least one token is available. If at least one token is available above the desired threshold, the priority policer 310 directs the packet to the priority policer 320 in a subsequent policing stage (e.g., policing stage K+1 380) and the priority policer 310 is charged (e.g., a token is removed). If at least one token is not available above the desired threshold, the priority policer 310 rejects the packet by directing the packet to the packet drop 317 and the priority policer 310 is not charged (e.g., a token is not removed).

Upon receiving the packets allowed by the priority policer 310 in the policing stage K 380, the priority policer 320 in the policing stage K+1 380 determines whether to allow, reject, or conditionally pass each packet through the priority policer 320 based on parameters associated with the priority policer 320. The priority policer 320 determines if the packet can be unconditionally allowed. For example, if the priority policer 320 is a multi-threshold token bucket policer, the priority policer 320 unconditionally allows a packet if at least one token is available above the threshold associated with the lowest priority value (e.g., the highest threshold in the token bucket policer). In this example, the packet is not assigned a priority value because the priority policer 320 allows the packet through the policer 320 without regard to any priority value. The priority policer 320 directs unconditionally allowed packets to the priority policer in a subsequent policing stage (not shown). Also, in this example, the priority policer 320 is charged (e.g., a token is removed) upon unconditionally allowing a packet.

If the packet is not unconditionally allowed, the priority policer 320 determines whether to reject or conditionally pass the packet through the priority policer 320. For example, if the priority policer 320 is a multi-threshold token bucket policer, the priority policer 320 rejects the packet if there are no tokens above the threshold associated with the highest priority value (e.g., the lowest threshold in the token bucket policer). In this example, the packet is not assigned a priority value because the priority policer 320 rejects the packet without regard to any priority value. The priority policer 320 directs rejected packets to the packet drop 327 associated with the priority policer 320. Also, in this example, the priority policer 320 is not charged (e.g., a token is not removed) upon rejecting a packet.

If the priority policer 320 in the policing stage K+1 380 rejects a packet, the priority policer 320 directs an undo command 319 to the priority policer 310 in the policing stage K 370. Upon receiving the undo command 319, the priority policer 310 undoes a charge (e.g., increments the token count by one) that it had previously applied by allowing the dropped packet, and the state (e.g., the token count) of the priority policer 310 is updated to the equivalent of what it would have been had the dropped packet not passed through the priority policer 310. Without receiving the undo command 319 and undoing the charge, the priority policer 310 may incorrectly be charged for a packet that does not proceed through all of the policing stages (e.g., policing stage K 370, policing stage K+1 380, and policing stage N 390).

If the priority policer 320 does not unconditionally allow or reject the packet, the priority policer 320 determines that the packet is conditionally passed through the priority policer 320. For example, if the priority policer 320 is a multi-threshold token bucket policer, the priority policer 320 determines the lowest priority value P(k) (e.g., the highest threshold in the token bucket policer) for which the policer 320 has an available token. The priority policer 320 returns a status code 323 indicating that the packet should be rejected if the priority value associated with the packet is eventually determined to be less than P(k).

The priority policer 320 directs conditionally passed packets 325 to the classifier 340. The priority policer 320 also directs the status code 323 indicating the lowest priority value P(k) to the classifier 340. The classifier 340 determines a priority value of each packet received from the priority policer 320 in the policing stage K+1 380. In some embodiments, the classifier 340 determines the priority value based on one or more of: the contents of a network protocol header associated with the packet, application data associated with the packet, or metadata associated with the packet.

The classifier 340 compares the determined priority value of the packet with the status code 323 indicating the lowest priority value received from the priority policer 320 to determine whether to reject the packet or direct the packet back to the priority policer 310 with the determined priority value. For example, if the classifier 340 determines that the priority value of the packet is P(m), and P(m) is less than P(k), the classifier 340 directs the packet to the packet drop 347 associated with the classifier 340 because the priority value of the packet falls below the lowest priority value at which the priority policer 320 would allow a packet. If the classifier 340 rejects a packet received from the priority policer 320 in the policing stage K+1 380, the classifier 340 directs an undo command 319 to the priority policer 310 in the policing stage K 370. Upon receiving the undo command 319, the priority policer 310 undoes a charge (e.g., increments the token count by one) that it had previously applied by allowing the dropped packet, and the state (e.g., the token count) of the priority policer 310 is updated to the equivalent of what it would have been had the dropped packet not passed through the priority policer 310.

In another example, if the classifier 340 determines that the priority value of the packet is P(s), and P(s) is greater than or equal to P(k), the classifier 340 directs the packet (e.g., prioritized packets 353) to the priority policer 320 because the priority value of the packet meets or exceeds the lowest priority value at which the priority policer 320 would allow a packet. In this example, the classifier 340 directs the determined priority value (e.g., P(s)) to the priority policer 310 along with the prioritized packet 353.

Upon receiving the prioritized packet 353 from the classifier 340, the priority policer 320 determines whether to allow or reject the prioritized packet through the priority policer 320 based on the priority value associated with the prioritized packet 353. For example, if the priority policer 320 is a multi-threshold token bucket policer, the priority policer 320 compares the priority value associated with the prioritized packet with the priority value (e.g., the threshold in the token bucket policer) at which at least one token is available. If at least one token is available above the desired threshold, the priority policer 320 directs the packet to the priority policer (not shown) in a subsequent policing stage and the priority policer 320 is charged (e.g., a token is removed). If at least one token is not available above the desired threshold, the priority policer 330 rejects the packet by directing the packet to the packet drop 327 and the priority policer 320 is not charged (e.g., a token is not removed). The priority policer 320 also directs an undo command 319 to the priority policer 310 in the policing stage K 370.

The priority policer 330 in the policing stage N 390 receives packets allowed by all of the previous policing stages (including the policing stage K 370 and the policing stage K+1 380). The priority policer 330 determines whether to allow, reject, or conditionally pass each packet through the priority policer 330 in the policing stage N 390 based on parameters associated with the priority policer 330. Upon receiving packets allowed by all of the previous policing stages, the priority policer 330 determines if the packet can be unconditionally allowed. For example, if the priority policer 330 is a multi-threshold token bucket policer, the priority policer 330 unconditionally allows a packet if at least one token is available above the threshold associated with the lowest priority value (e.g., the highest threshold in the token bucket policer). In this example, the packet is not assigned a priority value because the priority policer 330 allows the packet through the policer 330 without regard to any priority value. The priority policer 330 directs unconditionally allowed packets outside of the system 300. Also, in this example, the priority policer 330 is charged (e.g., a token is removed) upon unconditionally allowing a packet.

If the packet is not unconditionally allowed, the priority policer 330 determines whether to reject or conditionally pass the packet through the priority policer 330. For example, if the priority policer 330 is a multi-threshold token bucket policer, the priority policer 330 rejects the packet if there are no tokens above the threshold associated with the highest priority value (e.g., the lowest threshold in the token bucket policer). In this example, the packet is not assigned a priority value because the priority policer 330 rejects the packet without regard to any priority value. The priority policer 330 directs rejected packets to the packet drop 337 associated with the priority policer 330. Also, in this example, the priority policer 330 is not charged (e.g., a token is not removed) upon rejecting a packet.

If the priority policer 330 in the policing stage N 390 rejects a packet, the priority policer 330 directs an undo command 319 to the priority policers (e.g., priority policer 310, priority policer 320) in each of the previous policing stages (e.g., policing stage K 370, policing stage K+1 380). Upon receiving the undo command 319, the priority policers (e.g., priority policer 310, priority policer 320) in each of the previous policing stages (e.g., policing stage K 370, policing stage K+1 380) undoes a charge (e.g., increments the token count by one) that it had previously applied by allowing the dropped packet, and the state (e.g., the token count) of the priority policers (e.g., priority policer 310, priority policer 320) is updated to the equivalent of what it would have been had the dropped packet not passed through the priority policers (e.g., priority policer 310, priority policer 320).

If the priority policer 330 does not unconditionally allow or reject the packet, the priority policer 330 determines that the packet is conditionally passed through the priority policer 330. For example, if the priority policer 330 is a multi-threshold token bucket policer, the priority policer 330 determines the lowest priority value P(k) (e.g., the highest threshold in the token bucket policer) for which the policer 330 has an available token. The priority policer 330 returns a status code 333 indicating that the packet should be rejected if the priority value associated with the packet is eventually determined to be less than P(k).

The priority policer 330 directs conditionally passed packets 335 to the classifier 340. The priority policer 330 also directs the status code 333 indicating the lowest priority value P(k) to the classifier 340. The classifier 340 determines a priority value of each packet received from the priority policer 330 in the policing stage N 390. In some embodiments, the classifier 340 determines the priority value based on one or more of: the contents of a network protocol header associated with the packet, application data associated with the packet, or metadata associated with the packet.

The classifier 340 compares the determined priority value of the packet with the status code 333 indicating the lowest priority value received from the priority policer 330 to determine whether to reject the packet or direct the packet back to the priority policer 330 with the determined priority value. For example, if the classifier 340 determines that the priority value of the packet is P(m), and P(m) is less than P(k), the classifier 340 directs the packet to the packet drop 347 associated with the classifier 340 because the priority value of the packet falls below the lowest priority value at which the priority policer 330 would allow a packet.

If the classifier 340 rejects a packet received from the priority policer 330 in the policing stage N 390, the classifier 340 directs an undo command 319 to the priority policers (e.g., priority policer 310, priority policer 320) in the each of the previous policing stages (e.g., policing stage K 370, policing stage K+1 380). Upon receiving the undo command 319, each of the priority policers (e.g., priority policer 310, 320) undoes a charge (e.g., increments the token count by one) that it had previously applied by allowing the dropped packet, and the state (e.g., the token count) of the priority policers (e.g., priority policer 310, priority policer 320) is updated to the equivalent of what it would have been had the dropped packet not passed through the priority policers (e.g., priority policer 310, priority policer 320).

In another example, if the classifier 340 determines that the priority value of the packet is P(s), and P(s) is greater than or equal to P(k), the classifier 340 directs the packet (e.g., prioritized packets 355) to the priority policer 330 because the priority value of the packet meets or exceeds the lowest priority value at which the priority policer 330 would allow a packet. In this example, the classifier 340 directs the determined priority value (e.g., P(s)) to the priority policer 330 along with the prioritized packet 355.

Upon receiving the prioritized packet 355 from the classifier 340, the priority policer 330 determines whether to allow or reject the prioritized packet 355 through the priority policer 330 based on the priority value associated with the prioritized packet 355. For example, if the priority policer 330 is a multi-threshold token bucket policer, the priority policer 330 compares the priority value associated with the prioritized packet with the priority value (e.g., the threshold in the token bucket policer) at which at least one token is available. If at least one token is available above the desired threshold, the priority policer 330 directs the packet (e.g., allowed packets 360) outside of the system 300 and the priority policer 330 is charged (e.g., a token is removed) upon unconditionally allowing a packet. If at least one token is not available above the desired threshold, the priority policer 330 rejects the packet by directing the packet to the packet drop 337 and the priority policer 330 is not charged (e.g., a token is not removed). The priority policer 330 also directs an undo command 319 to the priority policers (e.g., priority policer 310, priority policer 320) in each of the previous policing stages (e.g., policing stage K 370, policing stage K+1 380).

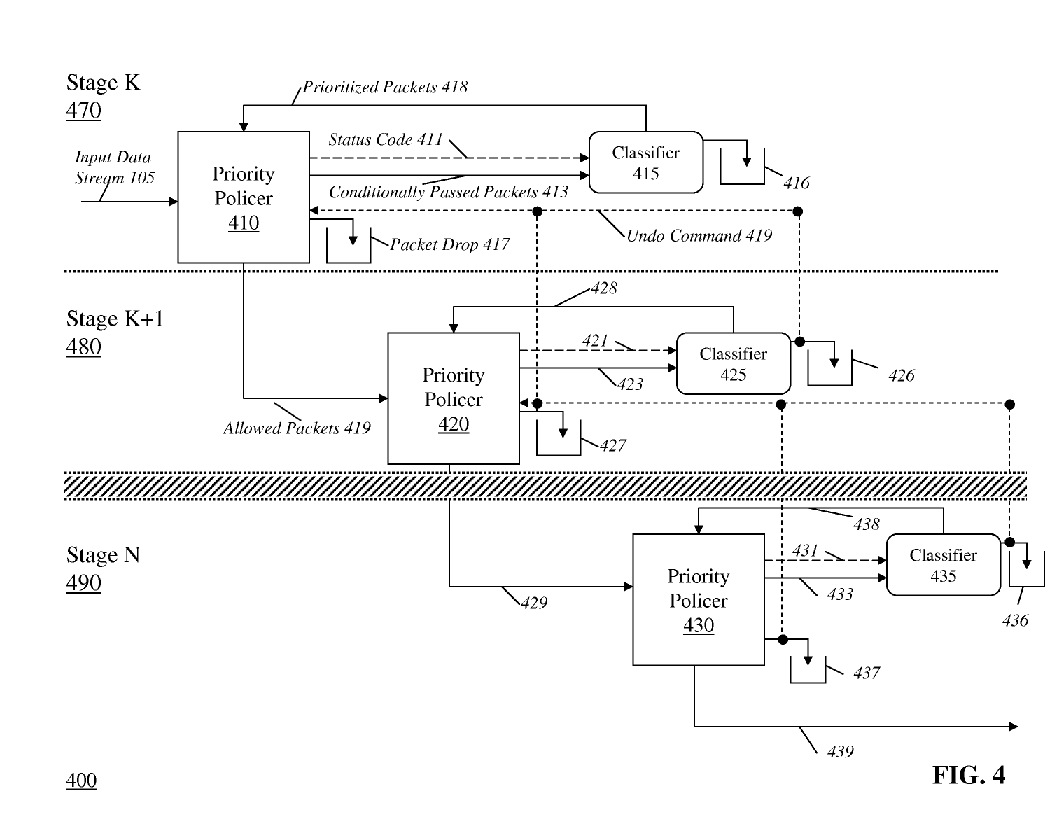

FIG. 4 is a block diagram of an exemplary multi-stage system 400 with a separate classifier per stage (e.g., classifiers 415, 425, and 435) for priority policing of requests with deferred determination of priority level, according to an illustrative embodiment of the invention. The system 400 includes an input data stream 105 and a plurality of policing stages (e.g., stage K 470, stage K+1 480, and stage N 490). Each policing stage 470, 480, 490 includes a priority policer (e.g., priority policer 410, 420, and 430, respectively) and a classifier (e.g., classifier 415, 425, and 435, respectively). The packet drops 417, 427, and 437 are each associated with a priority policer (e.g., priority policer 410, 420, and 430, respectively). The packet drops 416, 426, and 436 are each associated with a classifier (e.g., classifier 415, 425, and 435, respectively).

In one embodiment, the priority policer 410 in the policing stage K 470 receives an input data stream 105. The input data stream 105 includes unclassified packets. The priority policer 410 determines whether to allow, reject, or conditionally pass each packet through the priority policer 410 in the policing stage K 470 based on parameters associated with the priority policer 410. Upon receiving an unclassified packet from the input data stream 105, the priority policer 410 determines if the packet can be unconditionally allowed. For example, if the priority policer 410 is a multi-threshold token bucket policer, the priority policer 410 unconditionally allows a packet if at least one token is available above the threshold associated with the lowest priority value (e.g., the highest threshold in the token bucket policer). In this example, the packet is not assigned a priority value because the priority policer 410 allows the packet through the policer 410 without regard to any priority value. The priority policer 410 directs unconditionally allowed packets to the priority policer 420 in the policing stage K+1 480. Also, in this example, the priority policer 410 is charged (e.g., a token is removed) upon unconditionally allowing a packet.

If the packet is not unconditionally allowed, the priority policer 410 determines whether to reject or conditionally pass the packet through the priority policer 410. For example, if the priority policer 410 is a multi-threshold token bucket policer, the priority policer 410 rejects the packet if there are no tokens above the threshold associated with the highest priority value (e.g., the lowest threshold in the token bucket policer). In this example, the packet is not assigned a priority value because the priority policer 410 rejects the packet without regard to any priority value. The priority policer 410 directs rejected packets to the packet drop 417 associated with the priority policer 410. Also, in this example, the priority policer 410 is not charged (e.g., a token is not removed) upon rejecting a packet.

If the priority policer 410 does not unconditionally allow or reject the packet, the priority policer 410 determines that the packet is conditionally passed through the priority policer 410. For example, if the priority policer 410 is a multi-threshold token bucket policer, the priority policer 410 determines the lowest priority value P(k) (e.g., the highest threshold in the token bucket policer) for which the policer 410 has an available token. The priority policer 410 returns a status code 411 indicating that the packet should be rejected if the priority value associated with the packet is eventually determined to be less than P(k).

The priority policer 410 directs conditionally passed packets 413 to the classifier 415 associated with the priority policer 410. The priority policer 410 also directs the status code 411 indicating the lowest priority value P(k) to the classifier 415. The classifier 415 determines a priority value (e.g., P(s)) of each packet received from the priority policer 410 in the policing stage K 470. In some embodiments, the classifier 415 determines the priority value based on one or more of: the contents of a network protocol header associated with the packet, application data associated with the packet, or metadata associated with the packet.

The classifier 415 compares the determined priority value of the packet with the status code 411 indicating the lowest priority value received from the priority policer 410 to determine whether to reject the packet or direct the packet back to the priority policer 410 with the determined priority value. For example, if the classifier 415 determines that the priority value of the packet is P(m), and P(m) is less than P(k), the classifier 415 directs the packet to the packet drop 416 associated with the classifier 415 because the priority value of the packet falls below the lowest priority value at which the priority policer 410 would allow a packet.

If the classifier 415 determines that the packet should be directed back to the priority policer 410, the classifier 415 directs the prioritized packet 418 to the priority policer 410 in the policing stage K 470 along with the determined priority value P(s). Upon receiving the prioritized packet 418 from the classifier 415, the priority policer 410 determines whether to allow or reject the prioritized packet 418 through the priority policer 410 based on the priority value associated with the prioritized packet 418. For example, if the priority policer 410 is a multi-threshold token bucket policer, the priority policer 410 compares the priority value associated with the prioritized packet 418 with the priority value (e.g., the threshold in the token bucket policer) at which at least one token is available. If at least one token is available above the desired threshold, the priority policer 410 directs the packet to the priority policer 420 in a subsequent policing stage (e.g., policing stage K+1 480) and the priority policer 410 is charged (e.g., a token is removed). If at least one token is not available above the desired threshold, the priority policer 410 rejects the packet by directing the packet to the packet drop 417 and the priority policer 410 is not charged (e.g., a token is not removed).

Each subsequent policing stage determines whether to allow, reject, or conditionally pass each packet through the priority policer in the respective policing stage based on parameters associated with the priority policer in the respective policing stage. The following example uses the policing stage K+1 480 as the subsequent policing stage, but the steps are consistent in each respective policing stage before the final policing stage (e.g., policing stage N 490). The priority policer 420 determines if the packet can be unconditionally allowed, and directs unconditionally allowed packets to a priority policer in the subsequent policing stage (not shown). Also, in this example, the priority policer 420 is charged (e.g., a token is removed) upon unconditionally allowing a packet.

If the packet is not unconditionally allowed, the priority policer 420 determines whether to reject or conditionally pass the packet through the priority policer 420. The priority policer 420 directs rejected packets to the packet drop 427 associated with the priority policer 420. Also, in this example, the priority policer 420 is not charged (e.g., a token is not removed) upon rejecting a packet.

If the priority policer 420 in the policing stage K+1 480 rejects a packet, the priority policer 420 directs an undo command 419 to the priority policer 410 in the policing stage K 470. Upon receiving the undo command 419, the priority policer 410 in the policing stage K 470 undoes a charge (e.g., increments the token count by one) that it had previously applied by allowing the dropped packet, and the state (e.g., the token count) of the priority policer 410 is updated to the equivalent of what it would have been had the dropped packet not passed through the priority policer 410.

If the priority policer 420 does not unconditionally allow or reject the packet, the priority policer 420 determines that the packet is conditionally passed through the priority policer 420. The priority policer 420 directs conditionally passed packets 423 to the classifier 425 associated with the priority policer 420. The priority policer 420 also directs the status code 421 indicating the lowest priority value to the classifier 425. The classifier 425 determines a priority value of each packet received from the priority policer 420 in the policing stage K+1 480. In some embodiments, the classifier 425 determines the priority value based on one or more of: the contents of a network protocol header associated with the packet, application data associated with the packet, or metadata associated with the packet.

The classifier 425 compares the determined priority value of the packet with the status code 421 indicating the lowest priority value received from the priority policer 420 to determine whether to reject the packet or direct the packet back to the priority policer 420 with the determined priority value. For example, if the classifier 425 determines that the priority value of the packet is P(m), and P(m) is less than P(k), the classifier 425 directs the packet to the packet drop 426 associated with the classifier 425 because the priority value of the packet falls below the lowest priority value at which the priority policer 420 would allow a packet.

If the classifier 425 rejects a packet received from the priority policer 420 in the policing stage K+1 480, the classifier 425 directs an undo command 419 to the priority policer 410 in the policing stage K 470. Upon receiving the undo command 419, the priority policer 410 undoes a charge (e.g., increments the token count by one) that it had previously applied by allowing the dropped packet, and the state (e.g., the token count) of the priority policer 410 is updated to the equivalent of what it would have been had the dropped packet not passed through the priority policer 410.

If the classifier 425 determines that the packet should be directed back to the priority policer 420, the classifier 425 directs the packet (e.g., prioritized packets 428) to the priority policer 420 in the policing stage K+1 480 along with the determined priority value. Upon receiving the prioritized packet 428 from the classifier 425, the priority policer 420 determines whether to allow or reject the prioritized packet 428 through the priority policer 420 based on the priority value associated with the prioritized packet 428. If the priority policer 420 allows the prioritized packet 428, the priority policer 420 directs the packet to the priority policer in a subsequent policing stage (not shown) and the priority policer 420 is charged (e.g., a token is removed). If the priority policer 420 rejects the prioritized packet 428, the priority policer 420 directs the packet to the packet drop 427 and the priority policer 420 is not charged (e.g., a token is not removed). The priority policer 420 also directs an undo command 419 to the priority policer 410 in the policing stage K 470.

The priority policer 430 in the policing stage N 490 receives packets allowed by all of the previous policing stages (including the policing stage K 470 and the policing stage K+1 480). The priority policer 430 determines whether to allow, reject, or conditionally pass each packet through the priority policer 430 in the policing stage N 490 based on parameters associated with the priority policer 430. Upon receiving packets allowed by all of the previous policing stages, the priority policer 430 determines if the packet can be unconditionally allowed. The priority policer 430 directs unconditionally allowed packets outside of the system 400. Also, in this example, the priority policer 430 is charged (e.g., a token is removed) upon unconditionally allowing a packet.

If the packet is not unconditionally allowed, the priority policer 430 determines whether to reject or conditionally pass the packet through the priority policer 430. The priority policer 430 directs rejected packets to the packet drop 437 associated with the priority policer 430. Also, in this example, the priority policer 430 is not charged (e.g., a token is not removed) upon rejecting a packet.

If the priority policer 430 in the policing stage N 490 rejects a packet, the priority policer 430 directs an undo command 419 to the priority policers (e.g., priority policer 410, priority policer 420) in each of the previous policing stages (e.g., policing stage K 470, policing stage K+1 480). Upon receiving the undo command 419, the priority policers (e.g., priority policer 410, priority policer 420) in each of the previous policing stages (e.g., policing stage K 470, policing stage K+1 480) undoes a charge (e.g., increments the token count by one) that it had previously applied by allowing the dropped packet, and the state (e.g., the token count) of the priority policers (e.g., priority policer 410, priority policer 420) is updated to the equivalent of what it would have been had the dropped packet not passed through the priority policers (e.g., priority policer 410, priority policer 420).

If the priority policer 430 does not unconditionally allow or reject the packet, the priority policer 430 determines that the packet is conditionally passed through the priority policer 430. The priority policer 430 directs conditionally passed packets 433 to the classifier 435 in the policing stage N 490. The priority policer 430 also directs the status code 431 indicating the lowest priority value to the classifier 435. The classifier 435 determines a priority value of each packet received from the priority policer 430 in the policing stage N 490. In some embodiments, the classifier 435 determines the priority value based on one or more of: the contents of a network protocol header associated with the packet, application data associated with the packet, or metadata associated with the packet.

The classifier 435 compares the determined priority value of the packet with the status code 431 indicating the lowest priority value received from the priority policer 430 to determine whether to reject the packet or direct the packet back to the priority policer 430 with the determined priority value. For example, if the classifier 435 determines that the priority value of the packet is P(m), and P(m) is less than P(k), the classifier 435 directs the packet to the packet drop 436 associated with the classifier 435 because the priority value of the packet falls below the lowest priority value at which the priority policer 430 would allow a packet.

If the classifier 435 rejects a packet received from the priority policer 430 in the policing stage N 490, the classifier 435 directs an undo command 419 to the priority policers (e.g., priority policer 410, priority policer 420) in the each of the previous policing stages (e.g., policing stage K 470, policing stage K+1 480). Upon receiving the undo command 419, each of the priority policers (e.g., priority policer 410, 420) undoes a charge (e.g., increments the token count by one) that it had previously applied by allowing the dropped packet, and the state (e.g., the token count) of the priority policers (e.g., priority policer 410, priority policer 420) is updated to the equivalent of what it would have been had the dropped packet not passed through the priority policers (e.g., priority policer 410, priority policer 420).

If the classifier 435 determines that the packet should be directed back to the priority policer 430, the classifier 435 directs the prioritized packet 438 to the priority policer 430 along with the determined priority value.

Upon receiving the prioritized packet 438 from the classifier 435, the priority policer 430 determines whether to allow or reject the prioritized packet 438 through the priority policer 430 based on the priority value associated with the prioritized packet 438. If the priority policer 430 allows the packet, the priority policer 430 directs the packet outside the system 400. If the priority policer 430 rejects the packet, the priority policer 430 directs the packet to the packet drop 437 and the priority policer 430 is not charged (e.g., a token is not removed). The priority policer 430 also directs an undo command 419 to the priority policers (e.g., priority policer 410, priority policer 420) in each of the previous policing stages (e.g., policing stage K 470, policing stage K+1 480).

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, and/or other communication protocols.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). Mobile computing device include, for example, a Blackberry®. IP phones include, for example, a Cisco® Unified IP Phone 7985G available from Cisco Systems, Inc, and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein.

What is claimed is:

1. A method for priority-aware policing of data services, the method comprising:
directing each packet in a data stream to a policer;
determining whether to allow, reject, or conditionally pass each packet through the policer based on parameters associated with the policer;
directing each packet conditionally passed by the policer to a classifier associated with the policer;
determining, by the classifier, a priority value of each packet received from the policer;
directing, by the classifier, each prioritized packet to the policer; and
determining whether to allow or reject each prioritized packet through the policer based on the priority value.

2. The method of claim 1, wherein the step of determining whether to allow, reject, or conditionally pass each packet through the policer comprises conditionally passing each packet through the policer and directing the conditionally passed packets to the classifier.

3. The method of claim 1, wherein the step of determining whether to allow, reject, or conditionally pass each packet through the policer comprises rejecting or conditionally passing each packet through the policer and directing the conditionally passed packets to the classifier.

4. The method of claim 1, wherein determining a priority value for each packet received from the policer is based on one or more attributes of the packet.

5. The method of claim 4, wherein the one or more attributes of the packet comprise at least one of content data associated with the packet or metadata associated with the packet.

6. The method of claim 5, wherein the content data associated with the packet comprises at least one of data associated with one or more network protocol headers of the packet, data associated with one or more application headers of the packet or data associated with the packet payload.

7. The method of claim 5, wherein the metadata associated with the packet comprises at least one of a packet arrival interface, upstream router identification, VLAN identification or access medium identification.

8. The method of claim 1, further comprising:
charging the policer for each packet allowed through the policer; and
not charging the policer for each packet conditionally passed by the policer to the classifier.

9. The method of claim 1, wherein the classifier directs each prioritized packet to the policer if the priority value of the prioritized packet is higher than a minimum priority value.

10. The method of claim 1, wherein the step of determining whether to allow, reject, or conditionally pass each packet through the policer occurs independently of any priority value associated with each packet.

11. The method of claim 1, wherein the step of determining whether to allow, reject, or conditionally pass each packet through the policer is based on a minimum priority value.

12. A method for priority-aware policing of data services, the method comprising:
directing each packet in a data stream to a priority policer;
determining whether to allow, reject, or conditionally pass each packet through the priority policer based on parameters associated with the priority policer;
determining a minimum priority value for each packet conditionally passed by the priority policer;
directing each packet conditionally passed through the priority policer and the minimum priority value associated with each packet to a classifier associated with the priority policer;
determining, by the classifier, a priority value for each packet received from the priority policer;
rejecting, by the classifier, each packet if the determined priority value for each packet is less than the minimum priority value associated with each packet;
directing, by the classifier, each packet to the priority policer if the priority value for each packet is greater than or equal to the minimum priority value associated with each packet;
determining whether to allow or reject each packet through the priority policer based on the determined priority value.

13. The method of claim 12, further comprising
charging the policer for each packet allowed by the priority policer; and
not charging the policer for each packet conditionally passed by the priority policer to the classifier.

14. The method of claim 12, further comprising
charging the priority policer for each packet allowed by the priority policer;
charging the priority policer for each packet conditionally passed by the priority policer to the classifier; and
undoing the charge for each packet conditionally passed by the priority policer if the packet is rejected by the classifier.

15. The method of claim 12, wherein the step of determining whether to allow, reject, or conditionally pass each packet through the priority policer occurs independently of any priority value associated with each packet.

16. The method of claim 12, wherein the minimum priority value is the lowest priority value at which the priority policer would unconditionally allow a packet.

17. A method for priority-aware policing of data services with N policing stages, wherein N is greater than 2, and a classifier, the method comprising:
a) directing each packet in a data stream to a policer in a policing stage K;
b) determining whether to allow, reject, or conditionally pass each packet through the policer in the policing stage K based on parameters associated with the policer;
c) directing each packet conditionally passed by the policer in the policing stage K to the classifier;
d) determining, by the classifier, a priority value of the packet received from the policer in the policing stage K;
e) directing, by the classifier, the packet and the priority value of the packet to the policer in the policing stage K;
f) determining whether to allow or reject the packet through the policer in the policing stage K based on the priority value received from the classifier; and.
) directing each packet allowed by the policer in the policing stage K and the priority value of the packet to a policer in a subsequent policing stage K+1;
h) repeating steps b-g for each of the N policing stages.

18. A method for priority-aware policing of data services with N policing stages, wherein N is greater than 2, the method comprising:
a) directing each packet in a data stream to a policer in a policing stage K;
b) determining whether to allow, reject, or conditionally pass each packet through the policer in the policing stage K based on parameters associated with the policer in the policing stage K;
c) directing each packet conditionally passed by the policer in the policing stage K to a classifier in the policing stage K;
d) determining, by the classifier in the policing stage K, a priority value of the packet received from the policer in the policing stage K;
e) directing, by the classifier in the policing stage K, the packet and the priority value of the packet to the policer in the policing stage K;
f) determining whether to allow or reject the packet based on the priority value of the packet received from the classifier in the policing stage K;
g) directing each packet allowed by the policer in the policing stage K and the priority value of the allowed packet to a policer in a subsequent policing stage K+1;
h) repeating steps b-g for each of the N policing stages.

19. A computer program product, tangibly embodied in a computer-readable storage medium, for priority-aware policing of data services, the computer program product including instructions operable to cause a data processing apparatus to:
direct each packet in a data stream to a policer;
determine whether to allow, reject, or conditionally pass each packet through the policer based on parameters associated with the policer;
direct each packet conditionally passed by the policer to a classifier associated with the policer;
determine, by the classifier, a priority value of each packet received from the policer;
direct, by the classifier, each prioritized packet to the policer; and
determine whether to allow or reject each prioritized packet through the policer based on the priority value.

20. A system for priority-aware policing of data services, the system comprising:
a policer configured to:
determine whether to allow, reject, or conditionally pass each packet in a data stream through the policer based on parameters associated with the policer;
direct each packet conditionally passed by the policer to a classifier associated with the policer;
determine, by the classifier, a priority value of each packet received from the policer;
direct, by the classifier, each prioritized packet to the policer; and
determine whether to allow or reject each prioritized packet through the policer based on the priority value.

21. A system for priority-aware policing of data services, the system comprising:
means for directing each packet in a data stream to a policer;
means for determining whether to allow, reject, or conditionally pass each packet through the policer based on parameters associated with the policer;
means for directing each packet conditionally passed by the policer to a classifier associated with the policer;
means for determining, by the classifier, a priority value of each packet received from the policer;
means for directing, by the classifier, each prioritized packet to the policer; and
means for determining whether to allow or reject each prioritized packet through the policer based on the priority value.
